(19) United States
(12) Patent Application Publication
(10) Pub. No.: US 2006/0199608 A1
(43) Pub. Date: Sep. 7, 2006

(54) Systems and methods for motion sensitive roaming in a mobile communication device

(75) Inventors: Doug Dunn, Chula Vista, CA (US); Henry Chang, San Diego, CA (US)

Correspondence Address: KYOCERA WIRELESS CORP., P.O. BOX 928289, SAN DIEGO, CA, 92192-8289, US

(73) Assignee: Kyocera Wireless Corp.

(21) Appl. No.: 11/070,583

(22) Filed: Mar. 1, 2005

(51) Int. Cl. H04M 1/00

(52) U.S. Cl. 455/552.1

(57) ABSTRACT

A method for selecting a mobile communication service such as an air interface and/or communication system can include selecting the communication service based on motion and/or location. The selection of communication system can be made to optimize the user experience based on the type of service required and the environment the mobile station is in. Additionally, within an air interface, service can be chosen based on the type of call and the environment that mobile communication device is in.

### FIELD OF THE INVENTION

The field of the invention relates generally to mobile communication devices and more particularly to systems and methods for selecting service based on motion information related to a mobile communication device.

### BACKGROUND OF THE INVENTION

Many mobile communication devices operate using only one type of wireless service, for example analog service. Mobile communication devices that operate using more than one type of wireless service are becoming more common. Different wireless services can use different air interfaces and/or different types of communication systems and protocols. Today, more and more air interfaces are emerging, including Global System for Mobile Communication (GSM), Code-Division Multiple Access (CDMA), CDMA2000, or Universal Terrestrial Radio Access (UTRA), to name just a few. Wireless data services are also generating new air interface standards including, High Rate Packet Data (HRPD), 802.11, 802.16, and 802.20, to name just a few. These wireless data systems could carry Voice Over Internet Protocol (VoIP.)

Often, these different systems will overlap. Ideally, a mobile communication device would be able to switch from system to system as required or to provide the best service for a particular function. The selection of a particular air interface, and/or communication system to use at a particular time will be a problem for a conventional mobile communication device that supports multiple air interfaces and/or communication systems, because there is no current mechanism to allow a mobile communication device to seamlessly determine the best system to use.

### SUMMARY OF THE INVENTION

A method for selecting a mobile communication system using motion to assist in determining when it is appropriate to switch from one mobile communication system to another. In one aspect, various motion-related information, such as direction and velocity, can be used to determine which communication system to use.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a flowchart illustrating an example method for using motion information to select a communication system in accordance with one embodiment;

FIG. 2 is a diagram illustrating a mobile communication system configured to implement the method of FIG. 1; and

FIG. 3 is a diagram illustrating an expanded preferred roaming list that can be used by the system of FIG. 2 to implement the method of FIG. 1.

### DETAILED DESCRIPTION

It is becoming practical to produce mobile communication devices, such as mobile telephone handsets, capable of operating in multiple air interfaces and/or communication systems. Generally, each of the communication systems has certain advantages and disadvantages depending on the situation. For example, an air interface that is optimized for voice may not be the best choice for a user that wants data services. Blindly searching for a system to acquire and use because the mobile communication device supports that air interface can significantly delay switching to the most appropriate system for the environment in which the mobile is located. This delay can increase significantly depending on how many air interfaces are supported and what roaming agreements the providers have for each air interface. Accordingly, selection of a communication system can be made to optimize the user experience based on the type of service required and the environment in which the mobile station resides.

In one embodiment, for example, a communication system for a mobile communication device can be selected from a predetermined list of available air interfaces and/or communication systems. Thus, the mobile communication device can select which system or systems to search for from the list based on the type of service employed by a user at a particular time; e.g., voice or high speed data services. Other factors can also contribute to the selection of a given system. For example, factors that can be used to select a system can include adequate radio link quality for the service in use, quality of service, cost of service, including taking into consideration any billing plans a subscriber might have, or the number of minutes a subscriber has on a particular service, whether the mobile communication device is plugged in or using battery power, how much battery power is left, or some combination thereof. How these criteria are applied and services selected can, depending on the embodiment, be modified by the user or service provider.

While these criteria are used to determine which system or systems the mobile communication device will attempt to acquire, and in some embodiments the order of those attempts, it may not be possible to acquire the system identified as optimum for a particular service for reasons beyond the control of the user and the mobile communication device, e.g., system is at capacity, or the system is temporarily shut down. In those cases where the optimum system cannot be acquired, acquisition of the next best system for that particular service should be attempted.

Before describing the figures, it should be noted that the examples presented are discussed generally in the context of a mobile device, specifically, a mobile telephone handset. It will be understood that the systems and methods described herein can be applied to any mobile communication device, including, but not limited to personal digital assistants (PDAs), pagers, etc.

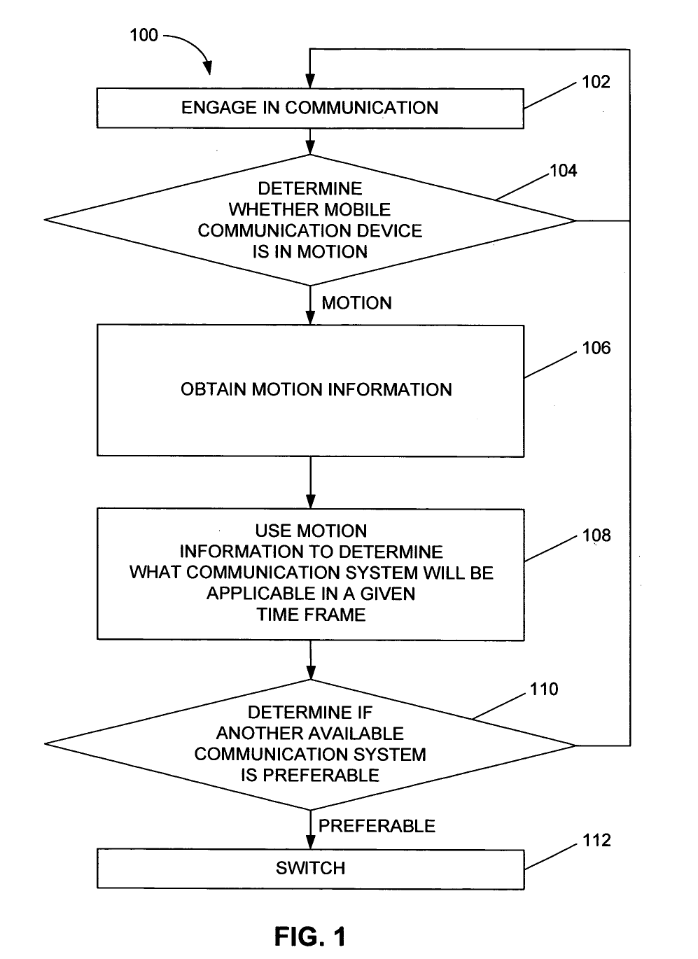

Accordingly, FIG. 1 is a flowchart illustrating an embodiment of a method for selecting a communication system in accordance with the systems and methods described herein. In step 102, a mobile communication device can engage in a communication. The communication device can be configured to use many different air interface standards, including, but not limited to Global System for Mobile Communication (GSM), Code-Division Multiple Access (CDMA), CDMA2000, or Universal Terrestrial Radio Access (UTRA) as well as data services such as High Rate Packet Data (HRPD), 802.11, 802.16, and 802.20. It will be understood that these data systems could carry Voice Over Internet Protocol (VoIP.) Moreover, mobile communication devices configured to implement the method of FIG. 1 can use some or all of the above communication systems as well as other communication systems.

In step 104, the mobile communication device can determine whether the mobile communication device is in motion. In certain embodiments, determining whether the device is in motion can comprise using Global Positioning System (GPS) Satellites to determine position and/or location information for the mobile communication device. This information can then be used to determine whether the device is in fact in motion. In another embodiment the determination step 104 can be made using Differential GPS (DGPS.) A DGPS is a system designed to improve the accuracy of GPS position determination by measuring small changes in variables to provide satellite positioning corrections. The DGPS can, in another embodiment comprise a Wide Area Augmentation System (WMS) GPS Receiver. WAAS is basically a DGPS implemented by the Federal Aviation Administration. Integration of GPS types of functionality into a mobile device is well known, and therefore will not be explained in detail here. Moreover, it will be understood that GPS based position and/or location services can, for example, be standalone, network assisted, or network based. It will also be understood that the systems and methods described herein can use any system or method that can provide information that can be used to determine motion of the mobile communication device.

Once it is determined that the mobile communication device is in fact in motion, then information related to that motion can be obtained by the mobile communication device in step 106. For example, the motion information can include position information and relative velocity. In other words, in order to determine, in step 104, that the device is in motion, several position measurements can be made within a certain time frame. If the position has changed, then the device is in motion. The time frame clearly needs to be selected so that it is sufficiently short to ensure that the device is in fact in motion if there is a change in position for the given time frame. The magnitude of the change in position combined with the time associated with the time frame can then be used to determine velocity. The direction of motion can also be determined, or at least estimated, based on the change in position. All such information, and the like, can be considered motion information. Further, it will be understood that the motion information can be determined by the mobile communication device, by a system external to the mobile communication device, e.g., the network, or some combination thereof.

The motion information obtained in step 106 can then be used to determine what other communication systems will be available within a given time frame in step 108 based on information stored in the mobile, alternatively it could be provided by the network at that time. For example, based on the direction and relative velocity determined in step 106, it can be determined that a wireless hotspot, e.g., an 802.11 system, will be available in 5 minutes or that several wireless Wide Area Network (WAN) systems are currently available. In one embodiment, system locations and type can be provided via an expanded preferred roaming list stored in the mobile communication device. One example of an expanded preferred roaming list is described in more detail below. In another embodiment, the mobile communication device may be able to probe the pilot signal level for various systems and use the knowledge of the signal strength of the systems obtained to determine the preferred system using, e.g. signal level constraints.

In step 110, the mobile device can then determine which of the available or soon to be available systems would be preferable. For example, if a subscriber initiates a high data rate file transfer, the user's mobile communication device can determine which of the available, or soon to be available, systems is the best system to support the communication. The mobile device can then be configured to switch to the preferred system, if it can be acquired, in step 112 in order to make the high data rate transfer. Similarly, if a system with a higher available bandwidth is going to be available soon, as determined with the aid of the motion information, then the mobile communication device can be configured such that it waits until the higher bandwidth system is available.

Factors that can be used to determine which system is the best system for a particular communication can include the required data rate, but can also include how long that system will be available based on the direction and speed of travel. The term “system is available” can be used to describe a condition whereby the mobile communication device can obtain a strong enough signal from the system such that the level of service is adequate for the type of service the system is intended for. In other words, the mobile communication device is within the coverage area of the system when the “system is available”.

Other factors that can be used to determine the best system can include cost, e.g., one communication system can be preferable when a user of a mobile communication device has a contract with the provider, or the provider has a partnership with a provider that a user of the mobile communication device has a contract with. Cost consideration can also include, for example, whether a user has minutes left on one available service, but not on another available service.

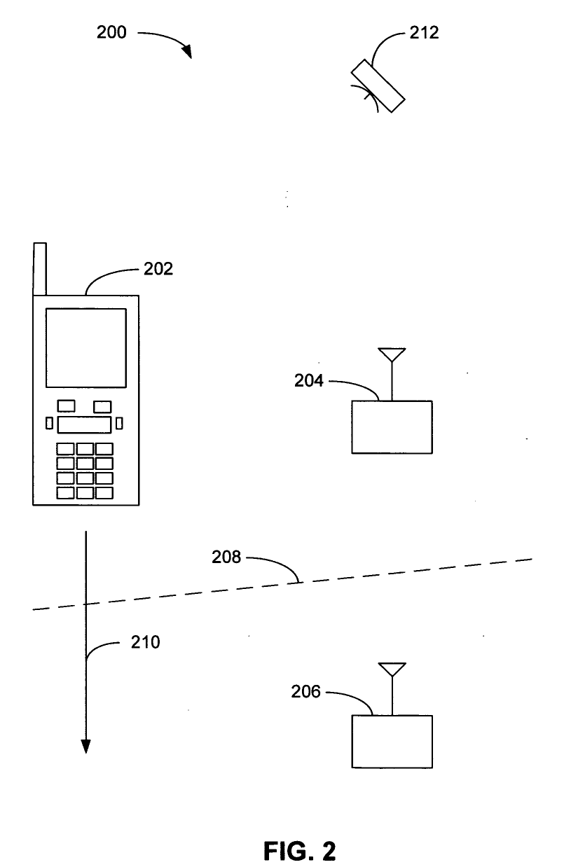

The determination that a system is preferable can also be made based on geographic location indicators, such as distance from a base station, or a predetermined coverage area. Determination based on geographic location will be discussed further with respect to FIG. 2.

Motion based performance capabilities of a particular communication system can also be used to determine which system is preferable. For example, certain systems or certain air interfaces can be considered better suited to serving a mobile communication device when it is in motion, while other systems or air interfaces can be better when a mobile communication device is stationary. How fast the device is traveling can also effect the determination of which system is preferable.

The application a user would like to use can also be used to determine what system is preferable. In some cases a systems can be better for a desired applications. For example, if a user would like to use a voice service, it can be preferable to select a voice communication system that is available as opposed to a data communication system. As mentioned, the bandwidth of a system or supported data rate can also be important factors.

Also mentioned above, an expanded preferred roaming list can be used to determine what systems will or will not be available. In other embodiments, however, such a determination can be made without the use of an expanded preferred roaming list. For example, motion based performance capabilities can be known generally for different types of communication systems. The determination can then be made based on a list of types of systems and the performance capabilities associated with the systems on the list. Thus, as certain systems are encountered or anticipated the list can be consulted to determine which is preferable. The list of motion based performance capabilities for different types of systems can also be included in, or with, an expanded preferred roaming list.

In certain embodiments, the mobile communication device can also include data regarding course and destination of the device. For example, some GPS based navigation systems include turn by turn directions from a starting location to an ending location. In one embodiment, a mobile communication device can use such data to determine what communication systems will be available and for how long. This information can then be used to determine what systems are preferable, e.g., based on cost, service requested, etc.

In another embodiment, knowledge of terrain can also be used to determine a preferable communication system. For example, a system that transmits line of sight may not be preferable in situations when, for example, a mountain is between the mobile communication device and a transmitter of the line of sight system.

In step 112, the mobile communication device can switch to the preferred communication system. In one embodiment, the switch of step 112 can be a soft handoff between the original communication system and the preferred system. In another embodiment, switch 112 can comprise a hard handoff. For example, if the communication device begins transmitting a large file, but then detects that a data service with higher bandwidth will be available shortly, then the device can be configured to stop the transmission, perform a hard handoff to the higher bandwidth system, and then reinitiate the transfer.

It should be noted that a trade off may need to be made, e.g., with respect to download speed and cost. For example, 802.11 can, in some cases be faster, but may not be the cheapest service available. The service selected can, thus, depend on the relative importance of price, download speed, file size, or length of the stream.

The switch of step 112 can, in some embodiments be over-ridden by the user. For example, generally, 802.11 may in some cases not be considered to be advantageous when a user is in motion, however, a user riding on a train that provides 802.11 service within the train may wish to override a determination that another service is preferable. Thus, the switch of step 112 can be automatic. Alternatively, the switch of step 112 can be displayed to a user, allowing the user to override the determination. Additionally, the selection of automatic switching or user override can, depending on the embodiment, be selected by the user. In another embodiment, the mobile communication device can detect and display the available systems for the user to select from. These systems can be displayed in a manner indicating their ranking based on the defined criteria.

FIG. 2 is a diagram illustrating a mobile communication system 200 in accordance with the systems and methods described herein. Mobile communication device 202 typically includes a processor coupled to a memory and a transceiver (not shown). Mobile communication device 202 can be configured execute instructions stored in memory to perform the steps illustrated by FIG. 1. For example, mobile communication device 202 can engage in a communication with a first communication system 204 as described with respect to step 102 of FIG. 1. First communication system 204 can, e.g., comprise a GSM, CDMA, CDMA2000, or UTRA system. First communication system 204 can also comprise, e.g., a wireless data only system such as HRPD, 802.11, 802.16, or 802.20.

Mobile communication device 202 can be in motion, as indicated by arrow 210. When it is determined that mobile communication device 202 is in motion (step 104) the mobile communication device 202 can be configured to then determine if another communication system will become available that is preferable (step 106).

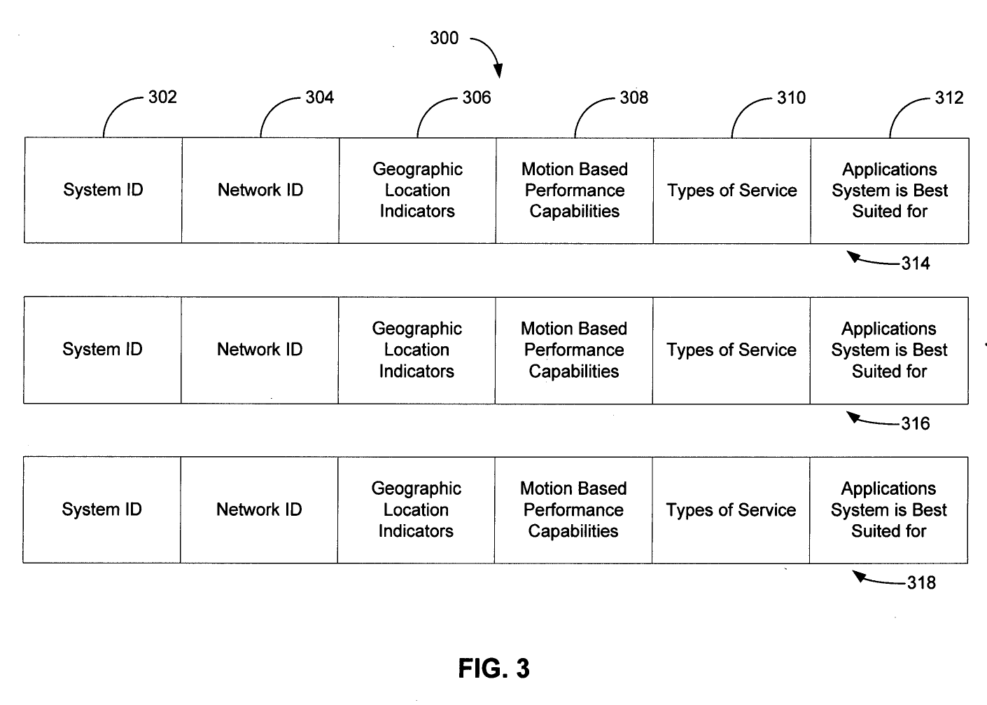

For example, in one embodiment, it can be preferable for the mobile communication device 202 to engage in communication with second communication system 206 if the mobile communication device 202 has crossed over the line 208. Line 208, can, e.g., be a boundary of an area serviced by second communication system 206. Information regarding communication system boundaries can be stored in an expanded preferred roaming list. Alternatively, line 208 can simply indicate that device 202 is now closer to system 206. Expanded preferred roaming lists will be discussed further with respect to FIG. 3.

In the embodiment of FIG. 2, however, device 202 is configured to determine whether device 202 is in motion (step 104) and to then obtain motion information (step 106), such as velocity and direction. Using this information, device 202 can be configured to determine that at a certain time system 206 will be preferable due to its closer proximity. Stated another way, device 202 can be configured to determine that at a certain time device 202 will cross boundary 208 making system 206 preferable for at least certain types of communications.

The determination that mobile communication device 202 is in motion can be made using location determination system 212. The location determination system 212 can be a global positioning system. It will be understood that global positioning systems generally include multiple satellites and can additionally include ground based components. Alternatively, the location determination system 212 can also be a ground based system.

FIG. 2 includes an example wherein a determination that another communication system is preferable can be made based on a boundary of an area serviced by second communication system 206. The determination that another communication system is preferable (step 106) can be based on other factors and combinations of factors as discussed with respect to FIG. 1.

FIG. 3 is a diagram illustrating a simplified example of an expanded preferred roaming list 300 in accordance with an embodiment of the systems and methods described herein. Each entry 314, 316, and 318 in expanded preferred roaming list 300 can include system ID 302 and network ID 304.

Each entry 314, 316, and 318 can also include information related to geographic location indicators 306. The geographic location indicators can indicate a location within an area serviced by the communication system. In another embodiment, geographic indicators 306 can include information about the boundaries of an area serviced by a communication system.

Each entry 314, 316, and 318 can also include motion based performance capabilities 308. Different communication systems can, for example, have higher or lower performance based on velocity of a mobile communication device. Thus, in one embodiment, a mobile communication device can select a service based on velocity of the mobile communication device and an expected level of performance at that velocity.

Expanded preferred roaming list 300 can also include types of services available 310. In an embodiment the selection of a communication service can be made based on, for example, a predetermined list of services available for the location and/or velocity of the mobile communication device.

Expanded preferred roaming list 300 can also include applications that a particular communication system and/or air interface is suited for 312. The selection of a particular communication system can be made based on selecting a suitable system and/or air interface from a list that is available at a given location. When the mobile chooses a system based on geographic location, type of service, motion, etc. the mobile may still not have service available due to changes in service, network maintenance, or accuracy of the geographic location of the system, etc. Thus, in certain embodiments, the mobile will try to acquire the system based on the preferred roaming list 300 and will successively go down the preferred roaming list 300 until it finds a system suitable for its application with strong enough signal from the system.

When determining that a communication system is preferable based on the applications that the system is best suited for, the determination can take multiple factors into account. For example, assume that one system, System A is good for voice communications and not as good for data communications. Further, assume that System B is good for data communications but not as good for voice communications; however, System B performs well when a device using System B is in motion. If a device is in motion, it can, thus be preferable to choose System B, even for voice communications.

In one embodiment a point system can be used to rate the available services. For example, various characteristics of the system, such as voice communication capability, data communication capability, performance of the system while in motion, etc., can be rated, e.g., from 1 to 5 points, 5 points being better than 1 point. As an example, system A can, e.g., be rated 5 for voice communication, 3 for data communication, and 1 for motion. System B can be rated 5 for data communication, 3 for voice communication, and 5 for motion. To choose a system, points can be added up and the system with the most points can be selected. In the present example, for voice communication while in motion, System A has 6 points, 5 points for voice communication and 1 point for motion. System B has 8 points, 3 points for voice communication and 5 points for motion. System B, in this example would thus be the preferable system.

Other factors that can be considered in determining a preferable system include, but are not limited to, cost of service, minutes remaining on the present service, and roaming partner agreements. For example, it may be desirable to select a lower cost service as apposed to a higher cost service. Another consideration that relates to cost is minutes remaining. In many cases customers buy service plans based on some number of minutes per month. The costs of using more than this allotment of minutes can be high relative to the cost for one month of service. It can be preferable to select a service that has minutes remaining as opposed to a service that does not have minutes remaining or a service that charges per minute. Another way that costs to the consumer can be managed is through roaming partner agreements. Roaming can occur when a mobile communication device uses another network. In some cases service providers may have agreements that can make it preferable, when roaming, to select a service with a roaming partner agreement.

It should be noted that other methodologies besides a point system can be used to rank systems in order to determine which service should be selected. For example, any methodology that uses some or all of the above characteristics and parameters to rank potential services can be implemented as part of the methods and systems described herein.

Generally a roaming list includes multiple entries 314, 316, 318. The number of entries may vary for different mobile devices. Further, each entry can be configured to include information that can allow a mobile communication device to make motion based decisions as described above.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

1. A mobile communication device comprising:
a processor,
a memory coupled to the processor;
a transceiver coupled to the processor, the processor further configured to:
engage in a communication using a first communication system;
determine whether the mobile communication device is in motion;
when the device is in motion, determine motion information for the device,
determine if another communication system is preferable based on the motion information; and
when it is determined that another communication system is preferable, switch to the other communication system.

2. The mobile communication device of claim 1, wherein the determination of motion step comprises using global positioning system signals to determine that the mobile communication device is in motion.

3. The mobile communication device of claim 2, wherein using global positioning system signals comprises processing the signals within the mobile communication device.

4. The mobile communication device of claim 2, wherein using global positioning system signals comprises processing the signals with assistance from a communication network.

5. The mobile communication device of claim 2, wherein using global positioning system signals comprises:
processing the signals within the mobile communication device; and,
processing the signals with assistance from a communication network.

6. The mobile communication device of claim 1, wherein the determination of motion step comprises using a plurality of position fixes to determine that the mobile communication device is in motion.

7. The mobile communication device of claim 1, wherein the determination that another communication system is preferable step comprises using an expanded preferred roaming list including geographical information.

8. The mobile communication device of claim 1, wherein the determination of motion comprises a determination of position, bearing, and velocity.

9. The mobile communication device of claim 1, wherein the processor is further configured to:
predict a future location; and,
schedule the switching to another communication system step based on the predicted future location.

10. The mobile communication device of claim 1, wherein the switching step comprises a handoff.

11. The mobile communication device of claim 10, wherein the handoff is delayed based on a prediction of a future location of the mobile communication device.

12. The mobile communication device of claim 1, wherein the determine if another communication system is preferable step comprises determining if another communication system is preferable for one of a voice communication, a data communication, and for a voice over internet protocol communication.

13. The mobile communication device of claim 1, wherein the determination that another communication system is preferable step comprises determining if another communication system is preferable for Quality of Service (QoS).

14. The mobile communication device of claim 1, wherein the determination that another communication system is preferable step comprises determining the preferable communication system based on available data rates on each of the first and second communication systems.

15. The mobile communication device of claim 1, wherein the determination that another communication system is preferable step comprises determining the preferable communication system based on availability of the first and second communication systems.

16. The mobile communication device of claim 1, wherein the determination that another communication system is preferable step comprises determining the preferable communication system based on access rights on each of the first and second communication systems.

17. The mobile communication device of claim 1, wherein the determination that another communication system is preferable step comprises determining the preferable communication system based on cost of service.

18. The mobile communication device of claim 1, wherein the determination that another communication system is preferable step comprises determining the preferable communication system based on minutes remaining on the present service.

19. The mobile communication device of claim 1, wherein the determination that another communication system is preferable step comprises determining the preferable communication system based on a roaming partner agreement.

20. A method for managing system access of a mobile communication device comprising, the method comprising:
engaging in a communication using a first communication system;
determining whether the mobile communication device is in motion;
when the device is in motion, determining motion information for the device;
determining if another communication system is preferable based on the motion information; and
when it is determined that another communication system is preferable, switching to the other communication system.

21. The method of claim 20, wherein the determination of motion step comprises using a plurality of position fixes to determine that the mobile communication device is in motion.

22. The method of claim 20, wherein the determination that another communication system is preferable step comprises using an expanded preferred roaming list including geographical information.

23. The method of claim 20, wherein the determination of motion comprises a determination of position, bearing, and velocity.

24. The method of claim 20, further comprising:
predicting a future location; and
scheduling the switching to another communication system step based on the predicted future location.

25. The method of claim 20, wherein the determine if another communication system is preferable step comprises determining if another communication system is preferable for one of a voice communication, a data communication, and for a voice over internet protocol communication.

26. The method of claim 20, wherein the determination that another communication system is preferable step comprises determining if another communication system is preferable for Quality of Service (QoS).

27. The method of claim 20, wherein the determination that another communication system is preferable step comprises determining the preferable communication system based on available data rates on each of the first and second communication systems.

28. The method of claim 20, wherein the determination that another communication system is preferable step comprises determining the preferable communication system based on availability of the first and second communication systems.

29. The method of claim 20, wherein the determination that another communication system is preferable step comprises determining the preferable communication system based on access rights on each of the first and second communication systems.

30. The method of claim 20, wherein the determination that another communication system is preferable step comprises determining the preferable communication system based on cost of service.

31. The method of claim 20, wherein the determination that another communication system is preferable step comprises determining the preferable communication system based on a roaming partner agreement.
